(19) United States
(12) Patent Application Publication
(10) Pub. No.: US 2011/0046983 A1
(43) Pub. Date: Feb. 24, 2011

(54) Health Care System, Method and Devices for Collaborative Editing of a Medical Document

(75) Inventors: Sheryl H. Soble, Birmingham, MI (US); Jeffrey S. Soble, Highland Park, IL (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Amaji Health Information Systems, Highland Park, IL (US)

(21) Appl. No.: 12/858,630

(22) Filed: Aug. 18, 2010

Related U.S. Application Data
(60) Provisional application No. 61/234,844, filed on Aug. 18, 2009.

(51) Int. Cl. G06Q 50/00

(52) U.S. Cl. 705/3

(57) ABSTRACT

A system for providing health care documentation is disclosed. The system includes one or more of a local location and a remote location including a plurality of devices including one or more patient examination note-taking devices, and one or more of patient diagnostic devices, wherein the plurality of devices are utilized to create and collaboratively modify a clinical document component file of an electronic medical document of a patient; a communication platform connected to the plurality of devices, wherein the communication platform permits communication between the one or more local location and the remote location; and one or more databases that are disposed at the one or more local location and remote location, wherein the one or more databases stores the electronic medical document of the patient.

### RELATED APPLICATION

This disclosure claims priority to U.S. Provisional Patent Application Ser. No. 61/234,844 filed on Aug. 18, 2009.

### FIELD OF THE INVENTION

The disclosure relates to health care and to a system, method and one or devices for collaborative editing of a medical document.

### DESCRIPTION OF THE RELATED ART

Modern medical technology has realized many benefits for mankind. For example, modern medical technology has permitted medical professionals to provide care for their patients with novel, relatively low-risk, minimally invasive procedures instead of conventional surgical techniques. Further, modern medical technology has permitted scientists to invent new and useful drugs that may alleviate troublesome symptoms, or, in some circumstances, cure a patient of a disease. Thus, as a result, modern medical technology has permitted medical professionals to successfully prolong the life of many patients while also reducing hospital stays and other costs associated with the care of a patient.

Although many benefits have been realized by utilizing modern medical technology, it is understood that a patient may not always receive care from, e.g., a “primary care physician” (e.g., a “family doctor”) that may, for example, intuitively know most, if not all, of a particular patient's medical history. As such, if, for example, a patient is being cared for by a medical professional (e.g., in an emergency room proximate a location where a patient may be vacationing) that is not familiar with a patient's health care history, the efficacy from the application of modern medical technology may be reduced if, for example, the emergency room medical professional has limited or no immediate access to a patient's health care history.

In addition to the above-identified concerns related to patient care, the medical industry, in general, is under constant pressure to contain costs (in relation to, e.g., use of physician/non-physician resources) without reducing a degree of care expected by patients. Therefore, a need exists in the art for the development of an improved system, method and one or more devices for improving health care delivery.

### BRIEF DESCRIPTION OF THE DRAWINGS

The disclosure will now be described, by way of example, with reference to the accompanying drawings, in which:

FIG. 1 is a view of a health care system for collaborative editing of an electronic medical document of a patient in accordance with an exemplary embodiment of the invention;

FIG. 2A is a view of some of a plurality of devices of the system of FIG. 1 being utilized by one or more local medical professionals to provide local health care for a patient in accordance with an exemplary embodiment of the invention;

FIG. 2B is a view of some of a plurality of devices of the system of FIG. 1 being utilized by one or more remote medical professionals to provide remote health care for the patient in accordance with an exemplary embodiment of the invention;

FIG. 3A is a view of a device of FIG. 2B that permits a remote medical professional to edit an image of the patient captured by a device of FIG. 2A in accordance with an exemplary embodiment of the invention;

FIG. 3B is a view of a device substantially similar to the device of FIG. 3A that is directly accessible by a local medical professional of FIG. 2A that concurrently displays stylus/pen strokes of the editing of the patient image by the remote medical professional of FIG. 3A in accordance with an exemplary embodiment of the invention;

FIG. 3C is a view of the device of FIG. 3B that permits the local medical professional to further collaboratively and concurrently edit the patient image that includes the edits by the remote medical professional in accordance with an exemplary embodiment of the invention;

FIG. 4 is a view of an electronic, collaboratively-edited medical document stored in a database in accordance with an exemplary embodiment of the invention; and

FIG. 5 is a flow chart diagram of a method for utilizing the system of FIG. 1 in accordance with an exemplary embodiment of the invention.

### DETAILED DESCRIPTION OF THE INVENTION

The Figures illustrate an exemplary embodiment of a health care system for permitting real-time, collaborative editing of one or more clinical document components contained within an electronic medical document during a doctor-patient encounter in accordance with an embodiment of the invention. Based on the foregoing, it is to be generally understood that the nomenclature used herein is simply for convenience and the terms used to describe the invention should be given the broadest meaning by one of ordinary skill in the art.

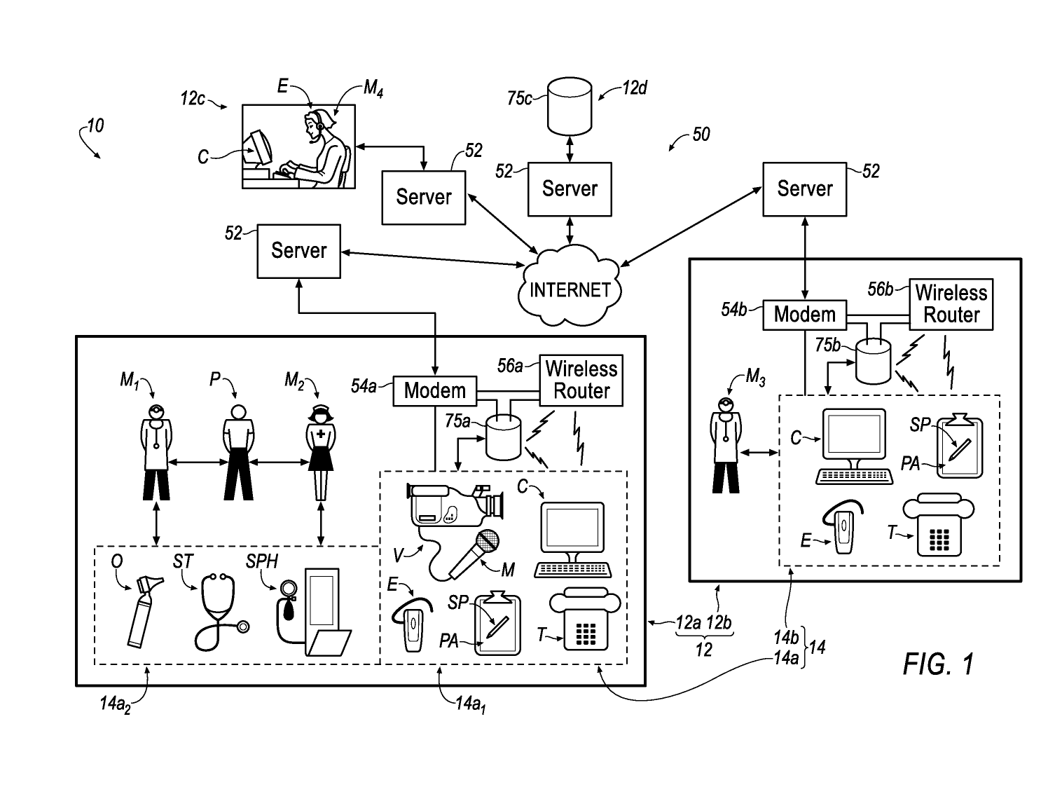

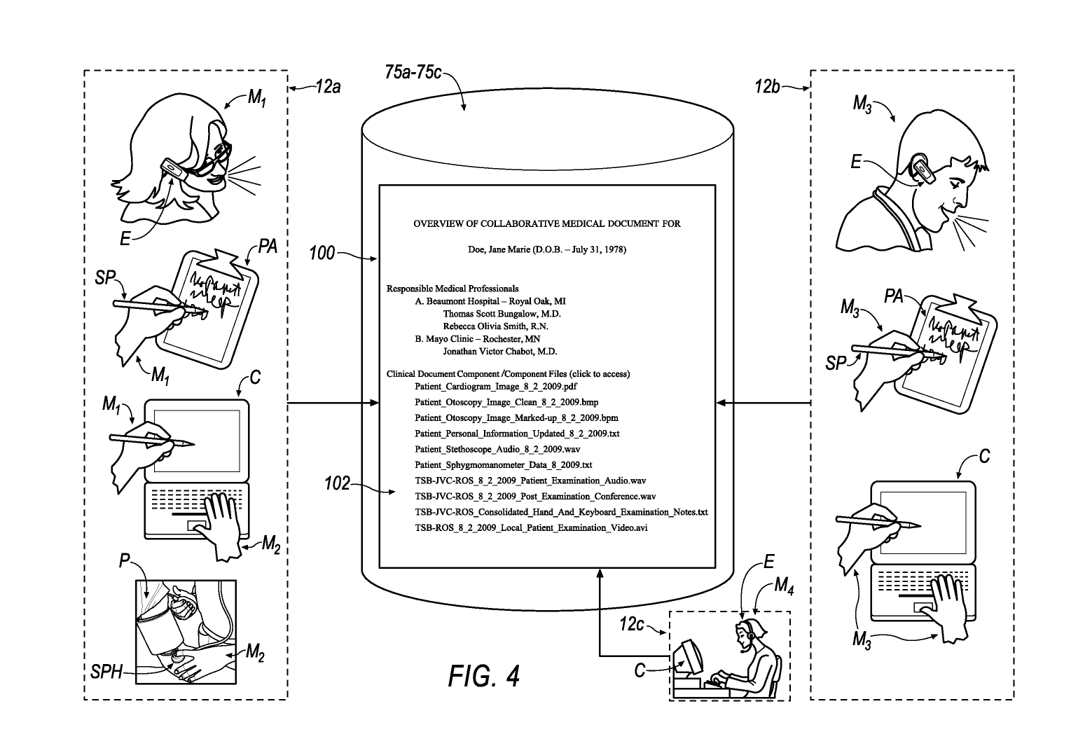

Referring to FIG. 1, a health care system is shown generally at 10 in accordance with an embodiment of the invention. In an embodiment, the system 10 functions by permitting the real-time, collaborative editing of one or more clinical document components 102 of an electronic medical document 100 (see, e.g., FIG. 4) of a patient, P, by one or more participants/medical professional, M₁-M₄, during a doctor-patient encounter. By permitting the collaborative editing of one or more clinical document components 102 of an electronic medical document 100, the system 10 may improve, for example, the efficacy from the application of modern medical technology in order to, for example, prolong the life of the patient, P, while also, for example, reducing hospital stays and other costs associated with providing health care for the patient, P.

A. Plurality of Locations 12

In an embodiment, the system 100 may include a plurality of locations 12 for providing health care to a patient, P. Although a first location 12a and a second location 12b of the plurality of locations 12 are shown, it will be appreciated that the system 10 is not limited to including two locations 12a, 12b and that the system 10 may include more than two locations, such as, for example, a third location 12c.

In an embodiment, the first location 12a may be referred to as a “local” location, and, another location (e.g., the second and/or third locations 12b, 12c) may be referred to as a “remote” location. In an embodiment, the local location 12a is distinguished from the remote locations 12b, 12c by virtue of the physical location of the patient, P, at the local location 12a (i.e., the patient, P, is physically “remote from” the second and/or third locations 12b, 12c).

Because the patient, P, may be physically located in one location at any given time, it will be appreciated that the plurality of locations 12 may include one local location 12a and one or more remote locations 12b, 12c. However, it will be appreciated that the terms “local” and “remote” should not be limited to be construed as, for example, different geographical locations. For example, in an embodiment, the local location 12a and one or more of the remote locations 12b, 12c may be different offices in the same hospital/building (i.e., the offices 12a, 12b and/or 12c are located at substantially the same geographical location with the difference between the two offices being that the patient, P, is located “remote from”/“not within” the office 12b and/or 12c).

Further, in an embodiment, it will be appreciated that the system 10 is not limited to being practiced with a plurality of locations 12. As such, in an embodiment, the system 10 may be practiced with, for example, the patient, P, located in a single location (e.g., the local location 12a) such that first and second medical professionals, M₁, M₂, collaboratively edit one or more clinical document components 102 of a medical document 100 at, for example, the same location/within the same office.

B. Participants/Medical Professionals, M₁-M₄

In an embodiment, health care is provided to the patient, P, by a plurality of medical professionals, ancillary healthcare workers and the like, which are shown generally at M₁-M₄. In an embodiment, each of the local and remote locations 12a, 12b, 12c may include more than one medical professional, M₁-M₄. According to the illustrated embodiment, the plurality of medical professionals, M₁-M₄, may include first and second local medical professionals, M₁, M₂, that are physically located at the local location 12a with the patient, P. The plurality of medical professionals, M₁-M₄, may further include, for example, one or more third and fourth, remote medical professionals, M₃, M₄, that are physically located at one or more of the remote locations 12b, 12c away from the physical location of the patient, P.

In an embodiment, it will be appreciated that each medical professional, M₁-M₄, of the plurality of medical professionals, M₁-M₄, may have a unique skill-set, degree/certification, amount of experience or the like. For example, in an embodiment, the first, local medical professional, M₁, may be a “primary care physician”/“family doctor.” Further, in an embodiment, the second, local medical professional, M₂, may be a registered nurse, medical technician, medical assistant or the like that assists the primary care physician, M₁. Further, in an embodiment, the third, remote medical professional, M₃, may be a doctor having, for example, more practical experience than the local doctor, M₁, or, alternatively, the remote doctor, M₃, may, for example, specialize in a particular field. In an embodiment, if, for example, the third, remote medical professional, M₃, may specialize in a particular field of medical practice, the medical practice may include, but is not limited to, for example: cardiology, dermatology, gastroenterology, gynecology, nephrology, neurology, oncology, ophthalmology, otolaryngology, proctology, radiology, rheumatology, urology or the like.

Although the above-described embodiment of the system 10 was directed to three medical professionals, M₁-M₃, it will be appreciated that the system 10 is not limited to being practiced with a particular number of medical professionals, such as three medical professionals, M₁-M₃. For example, in an embodiment, the system 10 may be practiced with a local nurse, M₂, and a remote doctor, M₃ (i.e., without the local doctor, M₁). Alternatively, in an embodiment, the system 10 may be practiced with a local doctor, M₁, and a local nurse, M₂ (i.e., without the remote doctor, M₃). Accordingly, it will be appreciated that the collaborative editing of a clinical document component 102 of the medical document 100 provided by the system 10 is not limited to a particular number of medical professionals, allied health professionals or the like, M₁-M₃.

Further, it will be appreciated that although the above-described embodiment of the system 10 is directed to a combination of two or more medical professionals, M₁-M₃, it will be appreciated that one or more persons, M₄, other than a nurse/doctor may participate in the system 10. For example, in an embodiment, the local doctor, M₁, may employ/hire a “non medical professional” (e.g., a “non-nurse/non-doctor”), such as, for example, a transcriptionist/documentation expert/typist/data entry agent (hereinafter, a “medical scribe, M₄”) that creates/collaboratively edits one or more clinical document components 102/electronic files 102 (e.g., by typing/transcribing documents prepared by the local doctor, M₁, such as, for example an audio broadcast, audio files/recordings, hand-written notes or the like).

Further, it will be appreciated that although the participant, M₄, may be referred to as a “non medical professional,” the medical scribe, M₄, may have some training in a medical-related field such as, for example, a medical librarian, a clinical billing agent, or the like, and, as such, in an embodiment, the medical scribe, M₄, may be referred to in some circumstances as a “medical professional.” Accordingly, although the forgoing disclosure may be described to include “medical professionals” in association with the system 10, it will be appreciated that any person, such as, for example, a “non medical professional,” medical scribe, M₄, or the like may be associated with the system 10 as well, and, in some circumstances, be also referred to as a “medical professional.” Thus, in an embodiment, persons that interact with the system 10 may be generically referred to as “participants” with the system 10.

If, for example, in an embodiment, the participant, M₄, is a medical scribe that is associated with a “medical scribe call center” that may be utilized by the local doctor, M₁, the system 10 may be further employed to examine data associated with clinical document component files 102 of the electronic medical document 100 in order to provide, for example, a method for scheduling real time participation of a remote medical scribe, M₄, during a patient-doctor encounter. For example, in an embodiment, the system 10 may employ human- or artificial-based intelligence that looks at information associated with one or more of a doctor's patient encounter schedule and/or the type of examination to be conducted on one or more patients, P, or the like in order to determine when and how many remotely-located medical scribes, M₄, will be needed to collaboratively assist a doctor, M₁, during a particular workday. As such, upon determining the number of remotely-located medical scribes, M₄, that will be required for “doctor X” on “day Y,” the system 10 may generate a request/order for services from the “medical scribe call center” such that one or more medical scribes, M₄, may be assigned to “doctor X” on “day Y” to collaboratively assist “doctor X” during his patient encounters. In addition, by monitoring the activities and patient processing/flow of the office in real time (e.g., by monitoring real time status entries in the electronic medical document 100, which may be related to patient check-in, activities of “doctor X,” activities of the medical assistants and the like), the “medical call center” might provision the services of its medical scribes, M₄, on a “just in time” basis. These techniques for closely matching and adjusting the resources of the “medical scribe call center” to the needs of providers seeing patients, P, at the point of care may result in an improvement to the cost-benefit ratio of a use of a medical scribe, M₄, in a wide range of clinical settings.

C. Plurality of Devices 14

In an embodiment, the system 10 may further comprise a plurality of devices 14. In an embodiment, the plurality of devices 14 are utilized by the plurality of medical professionals, M₁-M₃, in order to permit real-time collaborative creation and editing of a clinical document component 102 of the electronic medical document 100. In an embodiment, a “clinical document component 102” may be, for example, an electronic file that is used in association with a real-time encounter/examination of a patient, P. In an embodiment, the electronic medical document 100 may include one or more clinical document components 102.

In an embodiment, the plurality of devices 14 may be further distinguished according to the location of the plurality of devices 14. In an embodiment, for example, the plurality of devices may include, for example, a plurality of local devices 14a that are disposed at the local location 12a, and, in an embodiment, the plurality of devices 14 may include, for example, a plurality of remote devices 14b that are disposed at the remote location 12b, 12c.

In an embodiment, the plurality of local devices 14a may be sub-divided to include a first portion of local devices 14a₁ and a second portion of local devices 14a₂. In an embodiment, the first portion of local devices 14a₁ may include “patient examination note-taking” devices. The patient examination note-taking devices 14a₁ may include, for example, one or more devices that record/capture, for example, audio, video, graphics, drawings, typed notes, hand-written notes or the like. In an embodiment, the second portion of local devices 14a₂ may include, for example, one or more devices that record/capture, for example, physical diagnostics of the patient, P, including data such as, for example, vital signs, physiological parameters and blood readings. Accordingly, in an embodiment, the obtained patient vital data may include but is not limited to, for example: glucose readings, weight and the like.

In an embodiment, the plurality of remote devices 14b are not sub-divided to include a first and second portion of devices as shown and described above with respect to the plurality of local devices 14a. Rather, in an embodiment, the plurality of remote devices 14b may include patient examination note-taking devices that are substantially similar to the first portion of local devices 14a₁ that may include, for example, one or more devices that record/capture audio, video, graphics, drawings, typed notes, hand-written notes or the like.

In an embodiment, the patient examination note-taking devices 14a₁, 14b of the local and remote locations 12a, 12b may include for example: a video camera, V, /microphone, M, a computer workstation, C, a wireless (e.g., BLUETOOTH®) microphone/speaker earpiece, E, a smart-pen, SP, /paper-based computing platform (e.g. LIVESCRIBE®), PA, telephone, T, or the like. In an embodiment, the patient physical diagnostic devices 14a₂ may include, for example: an otoscope, O, a stethoscope, ST, sphygmomanometer, SPH, a set of devices for ophthalmologic measurements/recordings or the like.

As will be described in the foregoing disclosure, the plurality of devices 14 may be electronically connected to a communication platform 50 in order to transmit electronic data captured by one or more of the plurality of devices 14 in order to facilitate electronic, collaborative creation and editing of one or more clinical document components 102 associated with the doctor-patient encounter during which data was obtained by one or more of the plurality of devices 14. Accordingly, in an embodiment, it will be appreciated that any of the medical professionals, M₁-M₄, may be granted access to the captured data in order to edit/manipulate/supplement the data complied in one or more clinical document components 102 of the electronic document 100. Further, it will be appreciated that although several examples of devices of the plurality of devices 14 are discussed above, it will be appreciated that the system 10 is not limited to the examples discussed above and that the system 10 may include any number of or type of devices, as desired.

D. Communication/Collaboration Platform 50

In an embodiment, the one or more collaboratively-created and/or -edited clinical document components 102 of the electronic medical document 100 may be accessible by any of the medical professionals, M₁-M₄, at any of the local and remote locations 12a, 12b, 12c at, for example, any given time (i.e., before, during (e.g., in “real time”) or after an encounter with/examination of the patient, P). Further, in an embodiment, the medical professionals, M₁-M₄, at the local and remote locations 12a, 12b, 12c are permitted to communicate with one another at any given time (i.e., before, during (e.g., in “real time”) or after the encounter with/examination of the patient, P). Accordingly, in order to permit the above-identified modes of communication to take place, the system 10 may include a communication platform 50.

In an embodiment, the communication platform 50 may include, for example, an Internet-based platform that includes, for example, one or more servers 52, one or more modems 54a, 54b, one or more wireless routers 56a, 56b or the like. However, it will be appreciated that the communication platform 50 is not limited to an Internet-based platform; for example, the communication platform 50 can alternatively include a stand-alone or hybrid communication platform including one or more of a local area network, the Internet-based platform, or another form of wide-area network such as a satellite-based platform, a cellular/telephone-based platform or the like. However, for purposes of simplicity in describing an embodiment of the invention, a stand-alone, Internet-based communication platform 50 including servers 52 is discussed herein. Thus, it will be appreciated that although an Internet-based communication platform 50 is illustrated in the present disclosure, it will be appreciated that other communication platforms may also be utilized to supplement/supplant the utilization of the Internet.

In an embodiment, one or more of the plurality of devices 14 may be in direct (e.g., hard-wired) or indirect (e.g., wireless) communication with one or more of the modems 54a, 54b, wireless routers 56a, 56b, or the like. Accordingly, any information captured by any of the plurality of devices 14 may be directed to/through the communication platform 50 such that any of the medical professionals, M₁-M₄, may have, for example, substantially immediate/real-time access to the information captured by any of the plurality of devices 14.

E. Database 75

The one or more collaboratively-created and/or -edited clinical document components 102 of the electronic medical document 100 may be stored at any desirable location. In an embodiment, for example, the one or more clinical document components 102 of the electronic medical document 100 may be stored on a database 75a at the local location 12a. In an embodiment, for example, the one or more clinical document components 102 of the electronic medical document 100 may be stored on a database 75b at one or more of the remote locations 12b, 12c. In an embodiment, the one or more clinical document components 102 of the electronic medical document 100 may be stored on a database 75c at a remote location 12d, such as, for example, a data back-up facility/warehouse. Accordingly, it will be appreciated that the storage of the one or more clinical document components 102 of the electronic medical document 100 is not limited to a particular location and that the electronic medical document 100 may be stored at one or more of the locations 12a, 12b, 12c, 12d.

Further, in an embodiment, it will be appreciated that one or more of the plurality of devices 14 may be in direct (e.g., hard-wired) or indirect (e.g., wireless) communication with one or more of the databases 75a-75c. Accordingly, any information captured by any of the plurality of devices 14 may be directed to any of the local/remote databases 75a, 75b, 75c, as desired.

F. Example of Collaborative Creation and/or Editing of an Electronic Medical Document

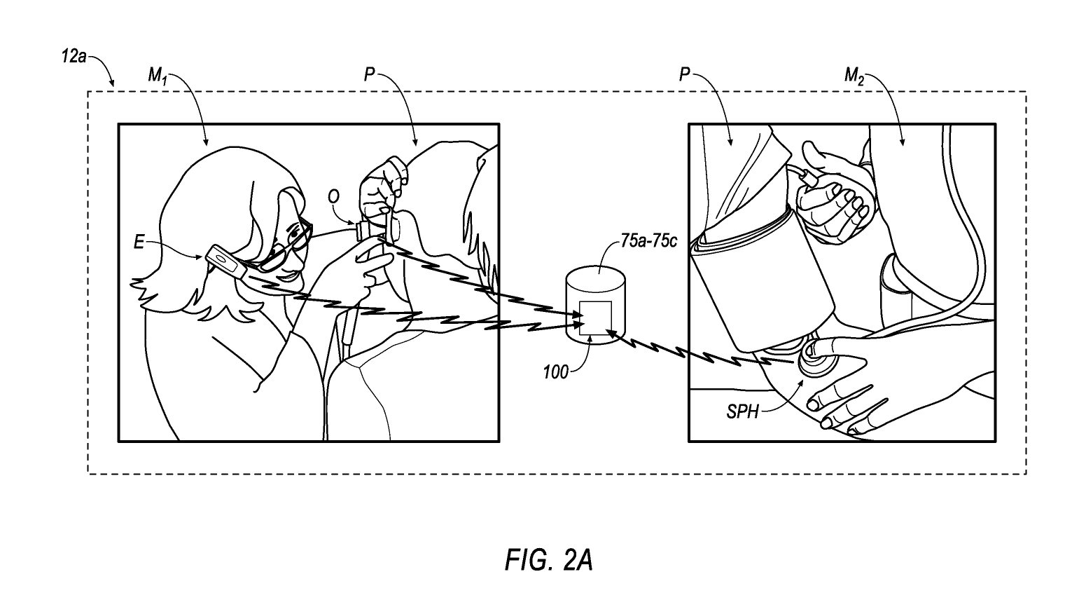

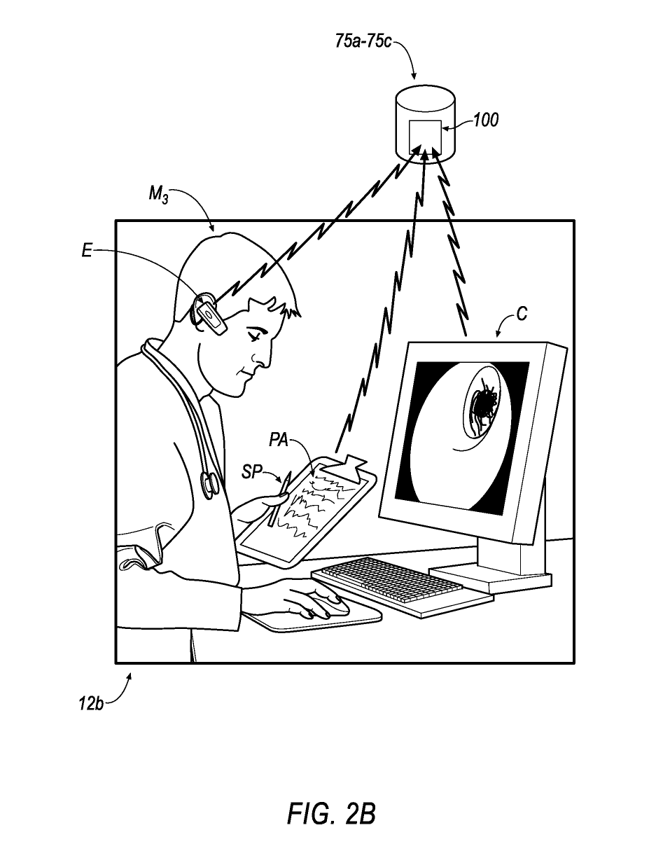

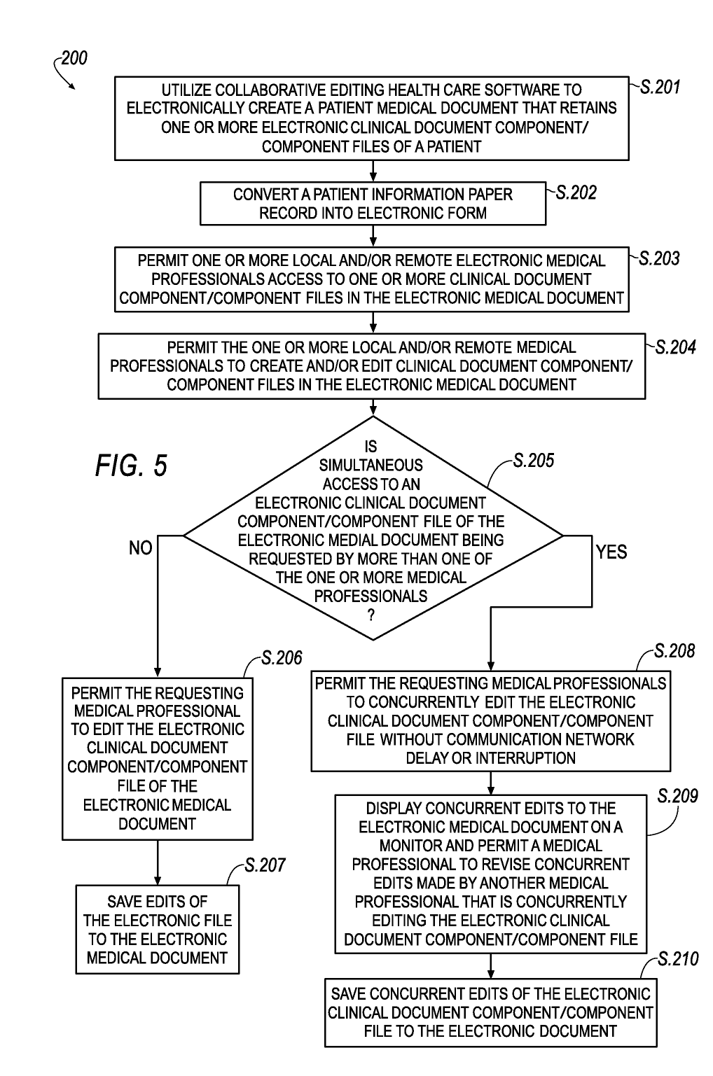

Referring to FIG. 2A-5, a method (see, e.g., 200 in FIG. 5 including steps S.201 through S.210) for utilizing the system 10 for collaboratively editing one or more clinical document components 102 of an electronic medical document 100 is shown according to an embodiment of the invention. It will be appreciated that although the method 200 is described in correlation to the treatment of an encounter with a patient, P, having a particular symptom (e.g., an ear infection), it will be appreciated that the embodiment discussed herein is for illustrative purposes and that the system 10 may be practiced for providing care to any number of patients, P, having any number/type of symptoms; as such it will be appreciated that the illustrated embodiment shown and discussed at FIG. 2A-5 should not be utilized to limit the scope of the claimed invention.

Referring initially to FIG. 1, in an embodiment, the local location 12a may include, for example an office of a primary care physician, M₁, that employs a registered nurse, M₂. In an embodiment, the patient, P, may have previously-patronized the physician's practice and have a prior (i.e., paper-based) medical document located at the local location 12a.

In an embodiment, the primary care physician, M₁, may instruct one or more of the registered nurse, M₂, located at the local location 12a and/or the medical scribe, M₄, located at the remote location 12d to create a collaboratively-editable, clinical document component 102 for an electronic document 100 for the patient, P, by accessing, for example, novel, collaborative-editing medical documentation software that may be stored on, for example, the computer workstation, C. In an embodiment, the collaborative-editing medical documentation software may permit a plurality of clinical document components 102 (which may hereinafter be referred to as clinical document component files 102 shown in FIG. 4) to be associated with the electronic medical document 100. In an embodiment, one or more clinical document component files 102 comprise the electronic medical document 100.

In an embodiment, for example, the registered nurse, M₂, may start the process of creating a clinical document component 102 by utilizing the computer workstation, C, in order to gain access to the novel documentation software and subsequently create (see, e.g., step S.201), for example, a new clinical document component 102 (e.g., a text file) for the medical document 100 that may include, for example, known personal information of the patient, P, as well as any prior information in the paper-based medical record that may or may not be relevant to the current doctor-patient encounter. Further, in an embodiment, the known information of the patient, P, may be collated automatically from prior examinations of the patient, P, that were recorded in the collaborative medical record 100 or entered manually by, for example, a registered nurse, M₂, by way if a conventional pen-and paper (see, e.g., step S.202), which may have been scribed by, for example, the patient, P, the primary care physician, M₁, or the like.

In an embodiment, the known information of the patient, P, may include, but is not limited to, for example: date-of-birth, sex, marital status, blood type, children, food allergies, medication allergies, prescribed medications, prior surgeries, or the like. Once the known information of the patient, P, is entered into the software, the registered nurse, M₂, may subsequently save the information under a file name within the document 100. In an embodiment, the file name of the clinical document component 102 may be, for example, “Patient_Personal_Information_{—}7_{—}14_{—}2009.txt” in the electronic document 100. The electronic document 100, which may include the known patient information clinical document component file 102, may then be saved, for example, within one or more of the databases 75a, 75c.

At a later time, the patient, P, may contact the primary care physician, M₁, and request an appointment in order for the primary care physician, M₁, to investigate, for example, pains within the patient's ear. Upon scheduling an appointment for the patient, P, the primary care physician, M₁, may contact an ear, nose and throat (ENT) specialist, M₃, that is located at a remote location 12b in order for the ENT specialist, M₃, to remotely participate in the examination of the patient, P.

Just prior to the patient examination, the ENT specialist, M₃, may be granted access to the electronic, known patient information clinical document component file 102 (see, e.g., step S.203) that is saved in the electronic document 100 that may be stored on one or more of the databases 75a, 75c. In an embodiment, the ENT specialist, M₃, may access the clinical document component file 102 by way of the computer workstation, C, at the remote location 12b and type/write questions and/or examination notes (see, e.g., step S.204) for the primary care physician, M₁, to utilize during the examination of the patient, P, during the later-scheduled appointment. In an embodiment, the ENT specialist, M₃, may then re-save the patient information clinical document component file 102 as “Patient_Personal_Information_Updated_{—}8_{—}1_{—}2009.txt” in the document 100 on one or more of the databases 75a-75c.

Prior to the examination of the patient, P, simultaneous access (see, e.g., steps S.205, S.208) to any clinical document component file 102 stored in the document 100 on one or more of the databases 75a-75c may be granted to any of the patient examination note-taking devices 14a₁, 14b at each of the local and remote locations 12a, 12b, 12c. For example, in an embodiment, the computer workstation, C, at each of the local and remote locations 12a, 12b, 12c may simultaneously display the updated, known patient information clinical document component file 102, “Patient_Personal_Information_Updated_{—}8_{—}1_{—}2009.txt,” and, in an embodiment, during the course of the examination of the patient, P, notes that are typed/written by any of the medical professional, M₁-M₄, with, for example, the patient examination note-taking devices 14a₁, 14b may be dynamically and simultaneously displayed upon (see, e.g., step S.209), for example, a monitor of the computer workstations, C, such that all of the medical professionals, M₁-M₄, may have immediate access and insight to each other's notes with the ability to concurrently and collaboratively edit (see, e.g., step S.209) each other's notes (using, e.g., Operational Transformation (OT) technology). It will be appreciated that the above-discussed embodiment is not limited to adding information sequentially (at, e.g., an end of a clinical document component 102), but rather, the added information can be placed anywhere within the clinical document component 102 to the liking of any of the medical professionals, M₁-M₄, for a temporal sequence of events in the clinical context of the patient encounter. Further, in an embodiment, it will be appreciated that edits to the clinical document component 102 may include multimedia derived from one or more of the plurality of devices 14 used during the patient encounter, or from any external source of multimedia data relevant to the patient, P, such as, for example, radiological images, pathological images or the like.

In an embodiment, OT technology that is utilized in conjunction with the system 10 permits, for example, the concurrent editing of rich multimedia, text, XML documents/files or the like, which allows seamless and low latency concurrent modifications to a particular clinical document component 102 that is being concurrently edited by two or more of the medical professionals, M₁-M₄. In an embodiment, OT technology replicates a collaboratively-created/-edited/-shared clinical document component 102 at all sites where the clinical document component 102 is accessed and allows any user to edit any part of the clinical document component 102 at any time. In an embodiment, local editing operations of the clinical document component 102 are executed without being delayed or blocked whereas remote operations are transformed before execution. A lock-free, non-blocking property of the OT technology makes the local response time insensitive to networking latencies. Further, in an embodiment, it will be appreciated that OT technology permits random access and/or real-time editing capabilities such that a sequence of modifications to a clinical document component 102 of the document 100 may be stored in order to determine which participant authored a particular portion of the clinical document component 102 within the document 100 and at what time (i.e., in what order).

Accordingly, in an embodiment, the patient encounter examination may commence by the primary care physician, M₁, conducting a question/answer session with the patient, P, in order to obtain updates to the patient's personal information (e.g., in order to determine if the patient's ear troubles may have resulted from a change of physical activity, such as, for example, “swimmer's ear” resulting from the patient recently visiting a public swimming pool, or, alternatively a change in diet, which may be related to a potentially new food allergy, usage of non-medicinal supplements or the like). In an embodiment, the primary care physician, M₁, may also engage the patient, P, with questions that were suggested through the information entered by the ENT specialist, M₃, as described above.

In an embodiment, during the question/answer session, the electronic medical document 100 may be dynamically updated (i.e., updated “on the fly”/in “real time”) by utilizing one or more of the patient examination note-taking devices 14a₁. For example, as seen in FIG. 2A, in an embodiment, the primary care physician, M₁, may be wearing a wireless (e.g., BLUETOOTH®) microphone/speaker earpiece, E, such that the audible questions/answers may be captured by the wireless microphone/speaker earpiece, E; as the audible information is captured, a “clinical document component sound file” 102 may be dynamically created (see, e.g., step S.204) and saved (see, e.g., steps S.205 through S.207) in the electronic medical document 100 under the file name of, for example, TSB-JVC-ROS_{—}8_{—}2_{—}2009_Patient_Examaintion_Audio.wav. In an embodiment, it will be appreciated that the information related to a clinical document component 102 may be embedded/saved entirely within a file or separate files within the medical document 100.

In an embodiment, during the question/answer session, the dynamic updating of the clinical document component sound file 102 of the electronic medical document 100 may be not necessarily captured by merely recording the voice of an individual participating in the system 10. For example, in an embodiment, a machine-assisted transcription or human-assisted transcription of one or more participant's voices may be transcribed in order to create a clinical document component 102 in real-time. If, for example, a machine-assisted transcription is conducted, the system 10 may employ voice-recognition software that electronically transforms the audible sound of one's voice into text that may be inserted in real-time into an appropriate location within the active medical document 100.

Alternatively, if, for example, a human-assisted transcription is conducted, the primary care physician, M₁, may request that the system 10 employ a remotely-located medical scribe, M₄, that obtains a broadcast (e.g., via phone, satellite, voice-over-Internet-protocol)/recording of one or more of the participants' voices such that the medical scribe, M₄, may manually type the data in real-time into an appropriate location within the active medical record 100 such that the conversation may be archived in electronic form in any desirable format, such as, for example, a text file. Further, it will be appreciated that the remotely-located medical scribe, M₄, may add value to the real-time patient encounter by similarly using a wireless microphone/speaker earpiece, E, in order to communicate with/collaboratively edit a clinical document component 102 with the primary care physician, M₁. Thus, in an embodiment, it will be appreciated that the remotely-located medical scribe, M₄, may improve upon a conventional, serial-entry data procedure (i.e., record voice on tape, send tape, transcribe tape, review tape) by providing a novel, parallel-entry data procedure (i.e., record and transcribe in real time such that the primary care physician, M₁, may also review, in real time, the data entries created by the medical scribe, M₄, in the clinical document component 102 of the electronic medical document 100, as well as perform simultaneous data entry) such that the remotely-located medical scribe, M₄, may directly partake in the patient encounter with the primary care physician, M₁.

Further, in an embodiment, it will be appreciated that the medical scribe, M₄, may not only be a transcriptionist but also, for example, a medical librarian that may functionally locate (in real time) reference information for the primary care physician, M₁, which may be relevant to the patient's symptoms, in order to enhance/improve the primary care physician's care for the patient, P, as the medical scribe, M₄, enters information into the clinical document component 102 of the electronic medical document 100. Further, in an embodiment, the medical scribe, M₄, may not only be a transcriptionist but also, for example, a clinical documentation and/or billing expert that may remind the primary care physician, M₁, to document certain information during the patient encounter, which may have otherwise been accidently omitted by the primary care physician, M₁, in order to enhance/improve the quality and completeness of the document and support billing of for the patient encounter in order to prevent loss/recover costs that may have been otherwise lost/forfeited had the medical scribe, M₄, not reminded primary care physician, M₁, to document a specific procedure/service provided during the patient encounter as well as other relevant information thereto.

Further, as will be described in the foregoing disclosure, if any of the participants of the system 10 prepares hand-written notes utilizing a pen-and-paper (e.g., a smart-pen, SP, /paper-based computing platform, PA) or a stylus pen/computer monitor graphical interface, it will be appreciated that the medical scribe, M₄, may also physically obtain the hand-written notes and similarly transcribe that information into the appropriate location within the active medical document 100 and/or describe the nature of the drawings for subsequent archiving in electronic form in any desirable format, such as, for example, a text file or the like.

In an embodiment, the name of a clinical document component file 102 associated with the electronic medical document 100 may include any desirable characters or the like, such as, for example, an identifier, initials, a watermark, or the like that is associated with one or more of the medical professionals, M₁-M₄. Further, as seen in FIG. 4, the electronic medical document 100 may also include a listing of the one more medical professionals, M₁-M₄, as well as what hospital/medical scribe outsourcing company the one or more medical professionals, M₁-M₄, are associated with. Further, in an embodiment, the name of each clinical document component file 102 may include the date the clinical document component file 102 was created. As such, in an embodiment, the name of each of the clinical document component files 102 may include, for example, the initials (e.g., “TSB,” “JVC” and “ROS”) as well as, for example, the date of creation(e.g., “8_{—}2_{—}2009”) in the file name. Further, it will be appreciated that each of the clinical document component files 102 are not limited to a particular type or format (e.g., .pdf, .bmp, .txt, .wav, .avi or the like).

In an embodiment, it will be appreciated that as the clinical document component audio file 102 is being saved in the electronic medical document 100, one or more of the medical scribe, M₄, and the ENT specialist, M₃ (as seen in FIG. 2B), may be simultaneously hearing the audio of the primary care physician, M₁, and patient, P, by way of a speaker connected to, for example, the computer workstation, C, such that the audio may be transmitted by, for example, Voice over Internet Protocol (VoIP) technology. Alternatively, one or more of the medical scribe, M₄, and the ENT specialist, M₃, may be simultaneously hearing the audio of the primary care physician, M₁, and patient, P, by way of a wireless (e.g., BLUETOOTH®) microphone/speaker earpiece, E; in an embodiment, the audio captured by the wireless earpiece, E, may be transmitted by way of VoIP, cellular telephone service, or the like.

Further, it will be appreciated that if one or more of the medical scribe, M₄, and the ENT specialist, M₃, wishes to add to the conversation, one or more of the medical scribe, M₄, and the ENT specialist, M₃, may gain access to a microphone, M, associated with the computer workstation, C, or wireless earpiece, E, in order to audibly communicate with one or more of the primary care physician, M₁, registered nurse, M₂, and patient, P. As such, any audible insight added to patient question/answer session by one or more of the medical scribe, M₄, and the ENT specialist, M₃, may also be saved in the clinical document component sound file 102 of the document 100. Although a wireless earpiece, E, and/or microphone of a computer workstation, C, has been described above as being utilized to record the clinical document component audio file 102, it will be appreciated that a land-line telephone, T, and/or cellular telephone, T, may also be/alternatively be utilized to create the clinical document component audio file 102.

Further, in an embodiment, for example, as one or more of the primary care physician, M₁, ENT specialist, M₃, medical scribe, M₄, is/are conducting the patient question/answer session during the patient encounter, one or more of the primary care physician, M₁, ENT specialist, M₃, and medical scribe, M₄, may utilize a smart-pen, SP, /paper-based computing platform (e.g. LIVESCRIBE®), PA, of the patient examination note-taking devices 14a₁, 14b in order to hand-write notes on a piece of paper with the smart-pen, SP, which is subsequently converted into an electronic form for real-time, automatic, dynamic entry into, for example, the known patient information clinical document component file 102. In an embodiment, the conversion of hand-written notes into electronic form is conducted by way of the cooperation of the smart-pen, SP, and paper-based computing platform, PA, capturing the movements of the smart-pen, SP relative the paper of the paper-based computing platform, PA.

Further, in an embodiment, it will be appreciated that a clinical document component video file 102 may also be created and associated with the document 100. In an embodiment, the video may be captured by, for example, a video camera, V, or the like. In an embodiment, the name of the video file 102 may be, for example, TSB-ROS_{—}8_{—}2_{—}2009_Local_Patient_Examination _Video.avi.

Before, during or after the patient question/answer session, one or more of the primary care physician, M₁, and registered nurse, M₂, may utilize one or more of the patient diagnostic devices 14a₂ to obtain diagnostics of the patient, P. In an embodiment, as seen in FIG. 2A, the primary care physician, M₁, may utilize the otoscope, O, to examine the ear of the patient, P, during the patient encounter. Before, during or after the examination of the patient's ear, the registered nurse, M₂, may utilize the sphygmomanometer, SPH, to obtain the blood pressure of the patient, P.

In an embodiment, as the primary care physician, M₁, and registered nurse, M₂, are utilizing the otoscope, O, and sphygmomanometer, SPH, patient diagnostics captured by each device, O/SPH, is stored in a clinical document component file 102 within the document 100. In an embodiment, the otoscope, O, may also include, for example, a camera such that a clinical document component image/movie file 102 of the patient's ear canal may be saved in the electronic medical document 100. Similarly, in an embodiment, the blood pressure reading captured by the sphygmomanometer, SPH, may also be saved as a clinical document component 102 in the electronic medical document 100. The name of the clinical document component file 102 associated with imaging capture by the otoscope, O, may be, for example, Patient_Otoscopy_Image_Clean_{—}8_{—}2_{—}2009.bmp. Further, in an embodiment, the name of the clinical document component file 102 associated with the blood pressure reading captured by the sphygmomanometer, SPH, may be, for example, Patient_Sphygmomanometer_Data_{—}8_{—}2_{—}2009.txt.

As the clinical document component files 102 associated with the otoscope, O, and/or sphygmomanometer, SPH, are being created and associated with the medical document 100, one or more of the medical scribe, M₄, and the ENT specialist, M₃, may have access to and monitor the clinical document component files 102 within the medical document 100 on one or more of the plurality of devices 14b. In an embodiment, one or more of the medical scribe, M₄, and the ENT specialist, M₃, may open a clinical document component file 102 (see, e.g., step S.204) in order to enter hand-written comments created with the smart-pen, SP, /paper-based computing platform (e.g. LIVESCRIBE®), PA. In an embodiment, the name of the clinical document component file 102 may be, for example, TSB-JVC-ROS_Consolidated_Hand_And_Keyboard_Notes.txt. Upon one or more of the medical scribe, M₄, and the ENT specialist, M₃,initially creating the clinical document component file 102, the registered nurse, M₂, may notice the newly created clinical document component file 102 on the monitor of the computer workstation, C, and collaboratively edit/supplement the clinical document component file 102 in real time by adding typed notes to the clinical document component file 102 by utilizing a keyboard of the computer workstation, C. Further, the primary care physician, M₁, may similarly add information related to the clinical document component file 102 (see, e.g., steps S.205, S.208-S.209) in real time by hand-writing new notes and/or editing one or more of the nurse's, medical scribe's and/or ENT specialist's notes with a smart-pen, SP, /paper-based computing platform (e.g. LIVESCRIBE®), PA. As mentioned above, the collaborative-editing of the clinical document component file 102 may be enabled by the Operational Transformation (OT) technology in order to permit simultaneous/real-time editing and tracking of any participants' entries into any clinical document component file 102 of the document 100.

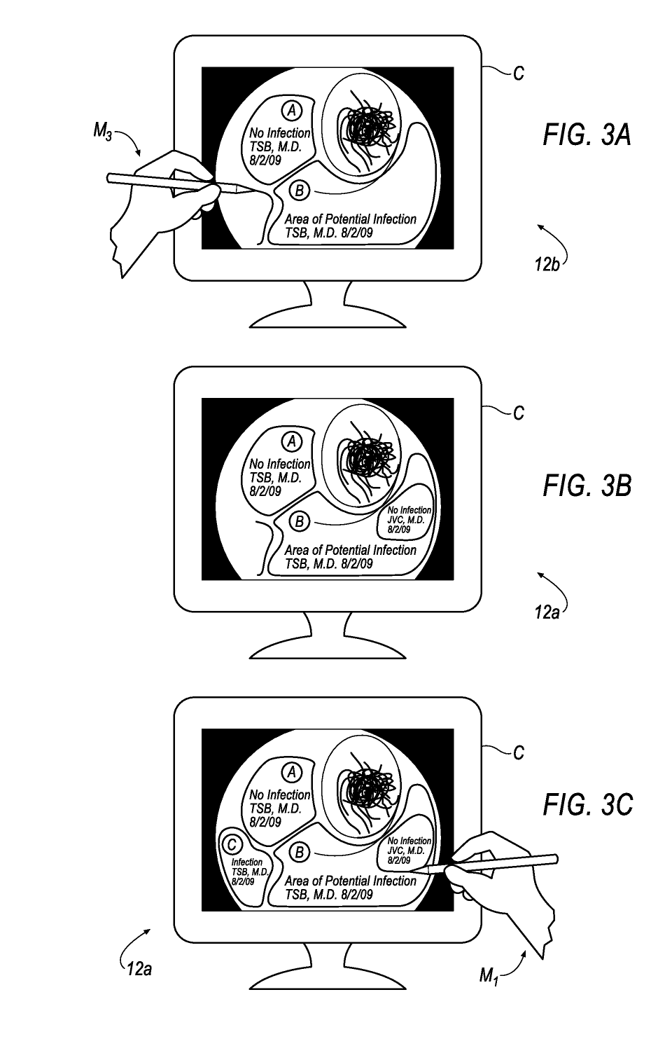

Further, in an embodiment, the ENT specialist, M₃, may open the clinical document component file 102 from the electronic medical document 100 to view the clinical document component image/movie file 102 and/or clinical document component 102 of the patient's ear canal that is/was captured by the camera associated with the otoscope, O. In an embodiment, as seen in FIG. 2B, the image may be displayed on a monitor of the computer workstation, C, at the remote location 12b. Referring to FIG. 3A, the ENT specialist, M₃, while viewing the image on the monitor of the computer workstation, C, may utilize a touch-screen stylus that enables the ENT specialist, M₃, to graphically draw on the monitor of the computer station, C.

In an embodiment, for example, ENT specialist, M₃, may circle ‘zones’ identified at “A,” “B” etc as shown in FIG. 3A in order to illustrate/identify areas of the ear canal that may be potentially infected. In an embodiment, “zone A” may include a note that indicates that the ENT specialist, M₃, does not see a concern related to an infection of the ear canal; however, “zone B” may include a note that indicates that the ENT specialist, M₃, may see a potential concern related to an infection of the ear canal.

Referring to FIG. 3B, in an embodiment, a monitor of a computer workstation, C, at the local location 12a may display the graphical notes through the medical document 100 (see, e.g., steps S.205, S.208) written by the ENT specialist, M₃. In an embodiment, the displaying of the graphical notes may be conducted in real time (see, e.g., the comparison of the stylus stroke at the remote location 12b in FIG. 3A with the graphical modification shown on the computer monitor at the local location 12a in FIG. 3B) such that one or more of the primary care physician, M₁, registered nurse, M₂, and medical scribe, M₄, may quickly understand the diagnosis or input offered by the ENT specialist, M₃.

Referring to FIG. 3C, in an embodiment, before, during or after the last stylus stroke of the ENT specialist, M₃ (which included an “infection zone C”), the primary care physician, M₁, may utilize a stylus to collaboratively edit/graphically indicate (see, e.g., step S.209) that a sub-zone of “zone B” does not appear to include an infection. Before, during or after the editing of the otoscope image, it will be appreciated that one or more of the primary care physician, M₁, registered nurse, M₂, ENT specialist, M₃, and medical scribe, M₄, may continue their audible dialogue so as to further supplement the clinical document component audio file 102 described above. Further, in an embodiment, once the primary care physician, M₁, and ENT specialist, M₃, have agreed upon the nature of the infection of the patient's ear canal, another, but “marked-up,” clinical document component image file 102 of the patient's ear canal may be saved within the document 100 and be given the name of, for example, Patient_Otoscopy_Image_Marked-up_{—}8_{—}2_{—}2009.bmp.

Once the examination of the patient, P, has concluded, one or more of the primary care physician, M₁, and ENT specialist, M₃, may verbally inform the nature of the ear infection to the patient, P, such that the audio file 102 is further supplemented. The patient, P, may then be excused from the local location 12a and one or more of the primary care physician, M₁, registered nurse, M₂, ENT specialist, M₃, and medical scribe, M₄, may continue their discussion and/or continue to collaboratively write/type real-time notes regarding the findings of the examination of the patient, P. If desired, the post-examination conference may be saved to the document 100 under a new clinical document component file 102 named, for example, TSB-JVC-ROS_{—}8_{—}2_{—}2009_Post_Examination_Conference.wav. In an embodiment, the post-conference notes may be added to the consolidated note clinical document component file 102 discussed above. Depending on the number of participants accessing the above-discussed clinical document component files 102, each of the clinical document component files 102 may be saved (see, e.g., steps S.207 or S.210) at any given time.

Although not discussed above, the document 100 may be further supplemented to include one or more prescribed medications for treating the ear infection, such as, for example, eardrops, antibiotics or the like that were prescribed by one or more of the primary care physician, M₁, and ENT specialist, M₃; such information may be saved, for example, in the patient information text clinical document component file 102. Further, in an embodiment, it will be appreciated that the document 100 may be further supplemented during subsequent encounters with the patient, P, when the patient, P, returns for an annual physical examination and/or further care to be given to the infected ear and that components of the original clinical document may be used to supplement any new documents related to these subsequent encounters.

Further, in an embodiment, if the ear infection persists, it will be appreciated that the electronic medical document 100 may be retrieved by a doctor other than the primary care physician, M₁, and ENT specialist, M₃. For example, in an embodiment, the patient, P, may be away from his/her home on a business trip; if, for example, the patient lapses into a state of unconsciousness such that the patient, P, may not be able to communicate upon the patient, P, being rushed to a nearby hospital, emergency medical technicians may locate, for example, the patient's identification (e.g., by way of a driver's license) and be granted access to the electronic medical document 100 in order to come to an immediate understanding of the patient's medical history. If, for example, the emergency medical technicians come to the understanding that the patient, P, was recently diagnosed with an ear infection, the emergency medical technicians may be able to quickly inform the appropriate specialist at the nearby hospital of the likely medical issue that the patient, P, may be suffering from (e.g., an infection of the ear travelling to the brain, which may have caused the state of unconsciousness). Thus, upon arriving at the nearby hospital, the specialist may retrieve one or more of the clinical document component files 102 from the electronic medical document 100 in order to view/replay any of the clinical document component audio, text and/or graphics files 102 that were prepared by one or more of the primary care physician, M₁, nurse, M₂, ENT specialist, M₃, and medical scribe, M₄.

Further, it will be appreciated that the specialist at the nearby hospital may contact one or more of the primary care physician, M₁, nurse, M₂, ENT specialist, M₃, and medical scribe, M₄, to inform them as to the current status of their patient, P, and/or invite them to partake in further, but remote, real-time collaborative care of their patient, P. As such, further collaborative editing of the clinical document component files 102 and/or creation of new clinical document component files 102 within the document 100 may take place by further utilizing the system 10 from the nearby hospital in a substantially similar manner as described above.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A system for providing health care documentation, comprising:
one or more of a local location and a remote location including
a plurality of devices including
one or more patient examination note-taking devices, and
one or more of patient diagnostic devices, wherein the plurality of devices
are utilized to create and collaboratively modify a clinical document component file of an electronic medical document of a patient;
a communication platform connected to the plurality of devices, wherein the communication platform permits communication between the one or more local location and the remote location; and
one or more databases that are disposed at the one or more local location and remote location, wherein the one or more databases stores the clinical document component file of the electronic medical document of the patient.

2. The system according to claim 1, wherein the collaborative modification of the clinical document component file of the electronic medical document of the patient is conducted by an Operational Transformation (OT) technology.
